(19) United States
(12) Patent Application Publication
(10) Pub. No.: US 2014/0188676 A1
(43) Pub. Date: Jul. 3, 2014

(54) AUTOMATED CONFIGURATION FOR NETWORK APPLIANCES

(71) Applicant: IPASS INC., Redwood Shores, CA (US)

(72) Inventors: Luis G. Marmolejo-Meillon, San Jose, CA (US); Barbara Nelson, San Mateo, CA (US); Marcio Aviles, Redwood Shores, CA (US); Evan Kaplan, Redwood City, CA (US)

(73) Assignee: IPASS INC., Redwood Shores, CA (US)

(21) Appl. No.: 13/732,202

(22) Filed: Dec. 31, 2012

(51) Int. Cl. G06F 15/177; G06Q 40/00

(52) U.S. Cl. CPC G06F 15/177; H04L 63/08; G06Q 40/00
USPC 705/34; 709/222; 726/5

(57) ABSTRACT

Some embodiments include a method for initially configuring a network appliance. The method can detect, by the network appliance, a subscriber network. The method can transmit, to a remote configuration service via the subscriber network, a request for configuration information for the network appliance, and receive, via the subscriber network, the configuration information, wherein the configuration information includes first parameters for the subscriber network, and second parameters for an access network for connecting computing devices to the network appliance. The method can also perform an automated initial configuration of the network appliance using the configuration information, wherein the automated configuration does not require user input, and wherein the automated configuration includes using the first parameters and the second parameters to configure the network appliance for use with the access network and the subscriber network.

### BACKGROUND

Coffee shops and other small enterprises frequently offer internet service to their customers. To make such internet services available, small enterprises typically purchase telecom services from large-scale telecom providers. These telecom services enable connectivity to telecom networks, and use of telecom components that process network traffic originating at small enterprises. Some small enterprises (a.k.a. small venues) authenticate prospective network users by forwarding access requests to remote private authentication servers. Such authentication may require that the small venue embed expensive components in the telecom network (e.g., regional authentication gateways running on telecom hardware.) Furthermore, large telecom companies do not typically offer small venues a wide range of service options. For example, large telecom companies may not let small venues select various network and billing policies that control network traffic and customer billing at the small venue. As a result, small venue operators could benefit from new systems that facilitate highly customizable network connectivity services.

Even though large telecom companies may provide services to small venues, small venues still may have to purchase and configure equipment for providing network services to their customers. For example, small venues may need to set-up local area WiFi access points that provide wireless connectivity to telecom networks. Small venue operators may not have technical expertise necessary for properly configuring and maintaining such networking equipment. As a result, small venue operators could benefit from new systems that make configuring network equipment easier.

### SUMMARY

Some embodiments include a method for initially configuring a network appliance. The method can detect, by the network appliance, a subscriber network. The method can transmit, to a remote configuration service via the subscriber network, a request for configuration information for the network appliance, and receive, via the subscriber network, the configuration information, wherein the configuration information includes first parameters for the subscriber network, and second parameters for an access network for connecting computing devices to the network appliance. The method can also perform an automated initial configuration of the network appliance using the configuration information, wherein the automated configuration does not require user input, and wherein the automated configuration includes using the first parameters and the second parameters to configure the network appliance for use with the access network and the subscriber network.

### BRIEF DESCRIPTION OF THE DRAWINGS

The present embodiments may be better understood, and numerous objects, features, and advantages made apparent to those skilled in the art by referencing the accompanying drawings.

FIG. 1 is a block diagram illustrating network appliances and remote services, according to some embodiments of the inventive subject matter.

FIG. 2 is a block diagram illustrating a hardware-based network appliance, according to some embodiments of the inventive subject matter.

FIG. 3 is a block diagram illustrating a software-based network appliance, according to some embodiments of the inventive subject matter.

FIG. 4 is a block diagram illustrating a webpage for selecting configuration options for network appliances, according to some embodiments of the inventive subject matter.

FIG. 5 is a flow diagram illustrating operations for configuring a network appliance, according to some embodiments of the inventive subject matter.

FIG. 6 is a flow diagram illustrating operations for processing network access requests, according to some embodiments of the inventive subject matter.

FIG. 7 is a flow diagram illustrating operations for providing and verifying configuration information to network appliances, according to some embodiments of the inventive subject matter.

### DESCRIPTION OF EMBODIMENT(S)

The description that follows includes exemplary systems, methods, techniques, instruction sequences and computer program products that embody techniques of the present inventive subject matter. However, some embodiments may be practiced without these specific details. In some instances, well-known instruction instances, protocols, structures and techniques have not been omitted for clarity.

### Introduction

As noted above, small venue operators may encounter challenges when offering network connectivity to their customers. Some embodiments of the inventive subject matter include a network appliance that enables small venue operators to provide internet connectivity without extensive telecommunications services from large telecom companies. Using the appliance, small venue operators need only obtain basic internet services to provide internet connectivity to their customers. Some embodiments of the appliance can perform can limit network access and authenticate users without aid of an authentication gateway embedded in the telecom system. That is, some embodiments can require network users to authenticate with a remote authentication service without an authentication gateway running in the telecom network. After users have been authenticated, the appliance may route network traffic to the internet without going through telecom gateways or the remote authentication service.

As noted above, small venue operators may lack technical expertise to properly configure and maintain equipment for providing network connectivity to small venue customers. Some embodiments provide a graphical user interface (GUI) and configuration components (e.g., a website, etc.) that enable small venue operators to easily configure the network appliance and/or other networking equipment. Using the GUI, small venue operators can select configuration options by answering basic questions about billing and network traffic, by choosing sets of pre-configured configuration parameters, or by enabling automated configuration. Some embodiments store configuration options in the cloud (i.e., in remote components accessible via a network) and download them onto the networking equipment. After a small venue has configured its networking equipment, embodiments store the configuration information in the cloud, in case the configuration information is needed later. Some embodiments periodically verify and/or update configuration parameters of the network appliance.

### Embodiments of the Network Appliance

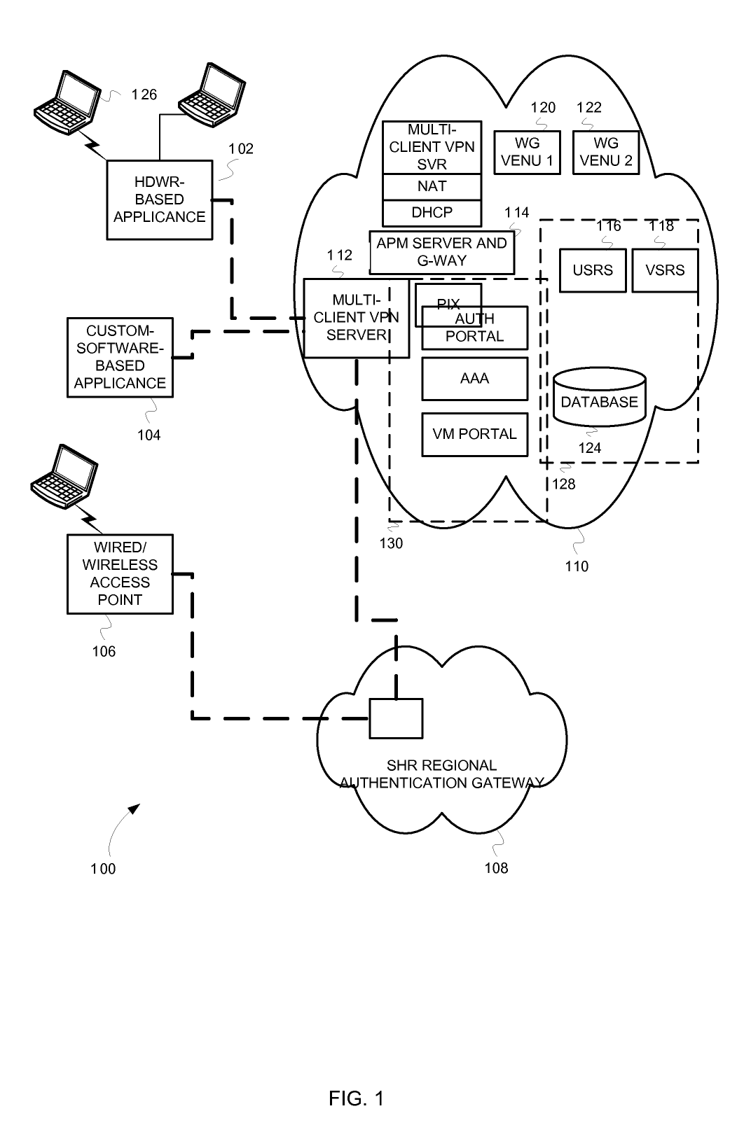

Some embodiments of the inventive subject matter include network appliances configured to provide network connectivity at venues, such as coffee shops, restaurants, bookstores, etc. In some instances, upon initial set-up, the network appliances can download configuration information over a network from a remote configuration service, thereby streamlining initial setup and maintenance of the network appliance. In addition to the remote configuration service, the network appliance may also obtain services from other remote components. For example, the appliance may connect with remote services to provide walled gardens to venue customers. The discussion of FIG. 1 describes these and other embodiments are more detailed.

FIG. 1 is a block diagram illustrating network appliances and remote services, according to some embodiments of the inventive subject matter. FIG. 1 shows three embodiments of a network appliance. As shown, the appliance can be a hardware-based appliance 102, custom software-based appliance 104, and a wireless access point 106 used in conjunction with a regional authentication gateway 108. The differences between the network appliances will be described later. Upon initial setup, the hardware-based appliance 102 can connect (via a subscriber network provided by a telecom company) with a remote service network 110 to obtain configuration information used for configuring the appliance.

The configuration information can include technical information for configuring access network parameters, subscriber network parameters, and billing/business parameters. An access network is a local area network that facilitates wireless access for the mobile device 126 to the appliance 102. The access network parameters can include Internet protocol (IP) addresses, Wi-Fi channel information, frequencies, Service Set Identifier information (SSID), WiFi Protected Access (WPA) protocol information, etc. The subscriber network comprises telecom company components that facilitate access between the appliance 102 and the remote services 110. The subscriber network may also facilitate access to the Internet. Subscriber network configuration information can include domain name server (DNS) information, dynamic host configuration protocol (DHCP) information, gateway information, etc. Billing/business parameters can include connectivity costs (e.g., how much a venue user pays to connect to the Internet), credit card service information, etc.

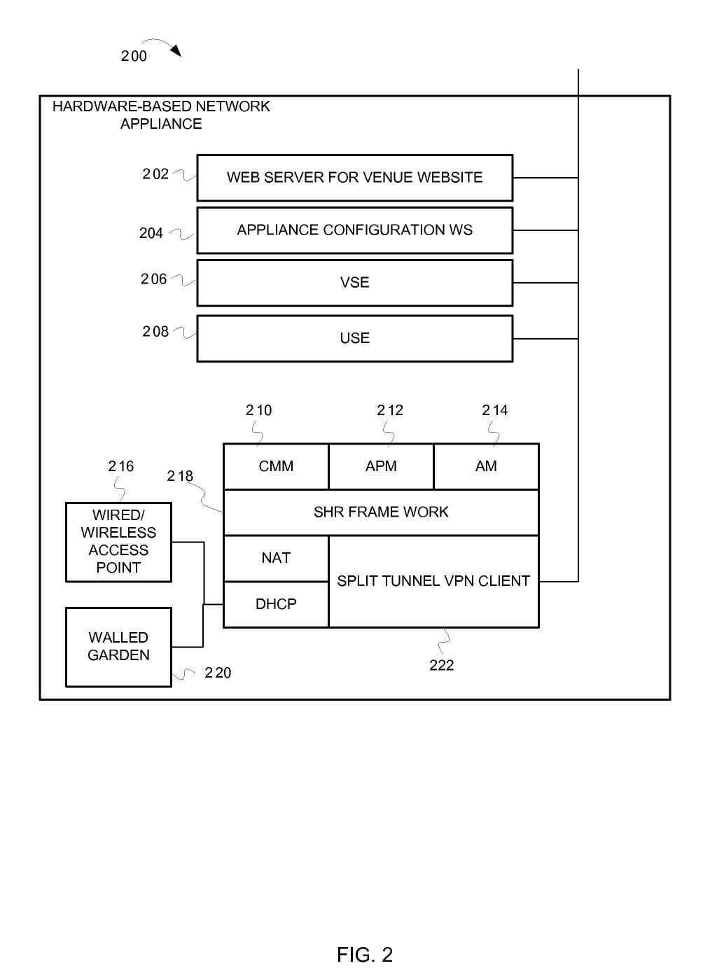

In some embodiments, as shown in FIG. 1, the thick dotted lines indicate a private network including the appliances and the remote services 110. In some embodiments, the a virtual private network is the only way for an appliance to communicate with the remote services (e.g., see FIG. 2's split tunnel VPN client).

As part of the configuration process, the appliance 102 provides certain identifying information to the remote configuration service 110. The identifying information can include a serial number for the appliance 102, and location information indicating a location at which the appliance resides (e.g., zip code, street address, longitude and latitude, etc.). Based on the identifying information, the remote configuration service can provide appropriate configuration information to the appliance 102. For example, based on the identifying information, the remote configuration service can provide configuration information appropriate for the appliance's access network and subscriber network. In some instances, the configuration service offers a website at which a venue operator can set billing/business parameters, which the configuration service pushes to the appliance 102. After the appliance 102 has been configured, the configuration service retains a record of all configuration settings for the appliance 102. The configuration service stores the configuration information in the database 124.

In FIG. 1, the remote configuration service 128 includes a database 124 for storing configuration information for devices that have already been configured, configuration options for devices that have not been configured, pre-set configuration profiles, etc. The remote configuration service 128 also includes a venue self-registration service (VSRS) 118, and a user self-registration service (USRS) 116. The VSRS 118 may verify configuration settings of the appliances (102, 104, and 106). For example, upon startup of an appliance that has been configured, VSRS 118 may receive a list of IP addresses from the appliance to verify that the appliance's static IP addresses have not changed. The USRS 116 can facilitates self configuration for new users. In some embodiments, the USRS 116 allows new users to register and creates accounts for those users. Using the user account, users can roam to numerous venue locations (e.g., venues that use the authentication service). The USRS 116 can carryout policies about how users pay, connection costs, etc. The USRS may offer configurable parameters related to how users are added/registered, which parts of the network are accessible to users, etc. Venue operators can set these parameters.

In FIG. 1, the remote services 110 also include an authentication service 130. The authentication service 130 authenticates user credentials received from the mobile devices 126. After a user's credentials have been authenticated, the remote services 110 instruct the appliance 102 to allow the user to access the Internet. In some embodiments, the authentication service 130 can verify passwords, digital certificates, or other authentication credentials. The authentication service 130 can authenticate users at a plurality of venues. In some embodiments, the authentication service 130 can support any number of venues and users. In some embodiments, the authentication service 130 is operated independent of the telecom company.

In FIG. 1, the remote services 110 include a multi-client virtual private network (VPN) server 112. The multi-client VPN server 112 enables the remote services 110 to contemporaneously service, over a virtual private network, a plurality authentication requests from a plurality of users. As will be described vis-à-vis FIG. 2, some embodiments of the appliance include VPN clients to facilitate secure authentication.

In FIG. 1, the remote services 110 also include walled gardens 120 and 122. In some embodiments, each of the walled gardens is for a particular venue. In some embodiments, a user can access content in the walled garden only after being successfully authenticated by the authentication services 130. The walled garden may offer limited web content, such as daily news stories, information about the venue, and other content provided by the venue operator. The walled gardens 120 and 122 can include web servers that provide content to the venue customers (i.e., the mobile devices 126).

This discussion continues with more details about embodiments of the network appliance.

FIG. 2 is a block diagram illustrating a hardware-based network appliance, according to some embodiments of the inventive subject matter. As shown FIG. 2, the network appliance 200 includes a wired/wireless access point 216. The access point 216 provides an interface to a local area access network and a subscriber network. The access point 216 can support any suitable connection technology, such as WiFi, Ethernet, etc. The network appliance 200 also includes a web server 202 for hosting a website for a venue. For example, if the venue is a restaurant, the web server 202 can host a website for the restaurant. In some embodiments, because the network appliance hosts the venue website, venue patrons need not access the internet to access the venue website. As a result, the website may be accessible to users who do not have network access credentials, or users who are otherwise unauthorized access the Internet via the network appliance 200 (e.g., users who have not paid a network access fee, etc.).

In FIG. 2, the network appliance 200 includes a walled garden 220. In some embodiments, the walled garden 220 offers content made available by the venue operator. In some embodiments, a user can access content in the walled garden 220 without being successfully authenticated by an authentication service (e.g., remote authentication service 130). The walled garden 220 may offer limited web content, such as daily news stories, information about the venue, and other content provided by the venue operator. The walled gardens 220 can include a web server that provide content to the venue customers (e.g., to the mobile devices 126).

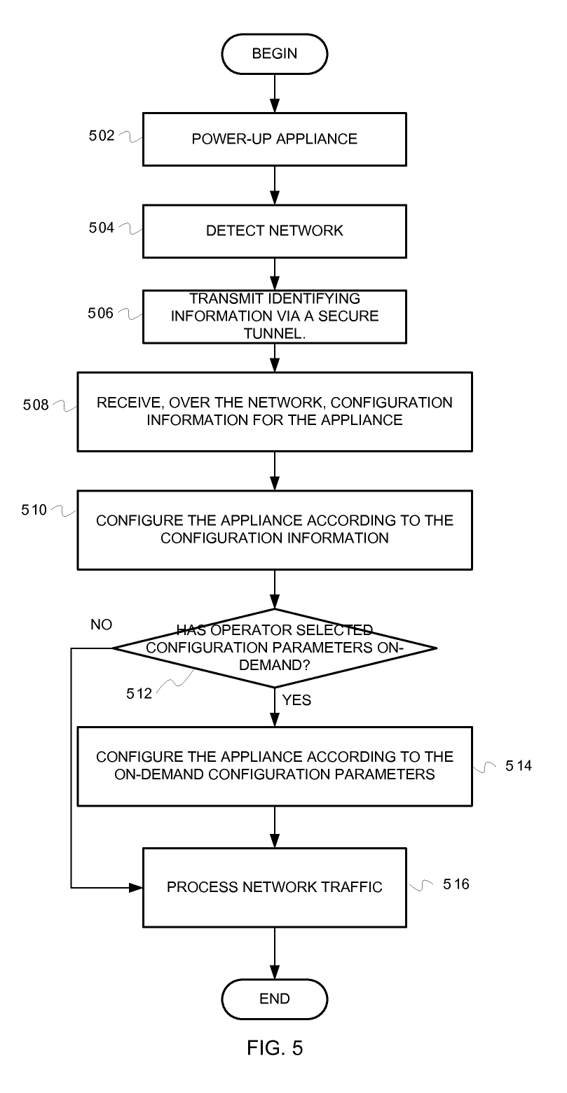

The network appliance 200 also includes a configuration management module 210 configured to perform automated configuration of the network appliance 200. The configuration manager module 210 can communicate with a remote configuration service, and procure configuration information for use in configuring the network appliance 200. In some embodiments, the configuration information includes parameters for configuring components (e.g., access point 216) to support an access network, subscriber network, and billing/business policies. Operations of the configuration management module 210 are described in detail below (see discussion of FIG. 5).

The authorization and payment module 212 communicates with remote services (e.g., the remote services 110) to facilitate payment transactions associated with providing venue customers access to the Internet. In some embodiments, the authorization and payment module 212 utilizes a secure tunnel (e.g., provided by the split tunnel client VPN 222) to communicate with a remote authorization and payment server (e.g., see 114). The remote authorization and payment server can determine a payment gateway to use for each transaction. In turn, the authorization and payment module 212 contacts the payment gateway for posting payment transactions on behalf of the venue. Determination of the payment gateway may be a function of multiple factors including schedule, country, payment type, and venue account. In some embodiments, a venue account is owned and controlled by the remote services network, so financial transactions are handled seamlessly by the remote services network. In other embodiments, the venue owns and controls the venue account. In such embodiments, payments flow directly to the venue account, whereas authorization records go to the remote services for storage and processing.

The network appliance 200 also includes a venue self-registration module 206 and user self-registration module 208.

The network appliance 200 also includes an authentication module 214. The authentication module 214 can receive credentials from users and transmit them to a remote authentication service via a secure tunnel provided by the split tunnel client VPN 222. In turn, the authentication module 214 receives responses from the remote authentication service, and communicates the responses to venue users. In some embodiments, the authentication module 214 enforces monetization policies, such as whether payment is required before it will authenticate a user.

In some embodiments, there are multiple remote services to choose from (e.g., there are multiple remote services to service different geographic regions. The appliance's SHR framework 218 can select an instance of remote services with which to communicate (e.g., the instance geographically closest).

The network appliance 200 also includes a split tunnel virtual private network client 222, which facilitates secure tunnels between the network appliance 200 and remote services, such as a remote authentication service. The split tunnel VPN client 222 can simultaneously maintain secure channels and unsecured channels. For example, the VPN client can establish a secure channel tunnel to a VPN server located at a remote service network, where the secure channel is used for authenticating venue customers. The VPN client 222 can also establish an unsecured channel to the Internet, where the unsecured channel is available for users who have already been authenticated by the remote authentication service. Such a split tunnel capability enables the network appliance 200 to reduce resource consumption (e.g., computation overhead) for network traffic originating from users that have been authenticated by the remote authentication service.

The components shown in FIG. 2 constitute an architecture for some embodiments of the network appliance. Although not shown in FIG. 2, embodiments of the network appliance can include processors, main memory (e.g., semiconductor random access memory), secondary storage (e.g., magnetic disk memory), and other components (e.g., application specific integrated circuits, communication buses, etc.) for supporting the architecture and functionality described herein.

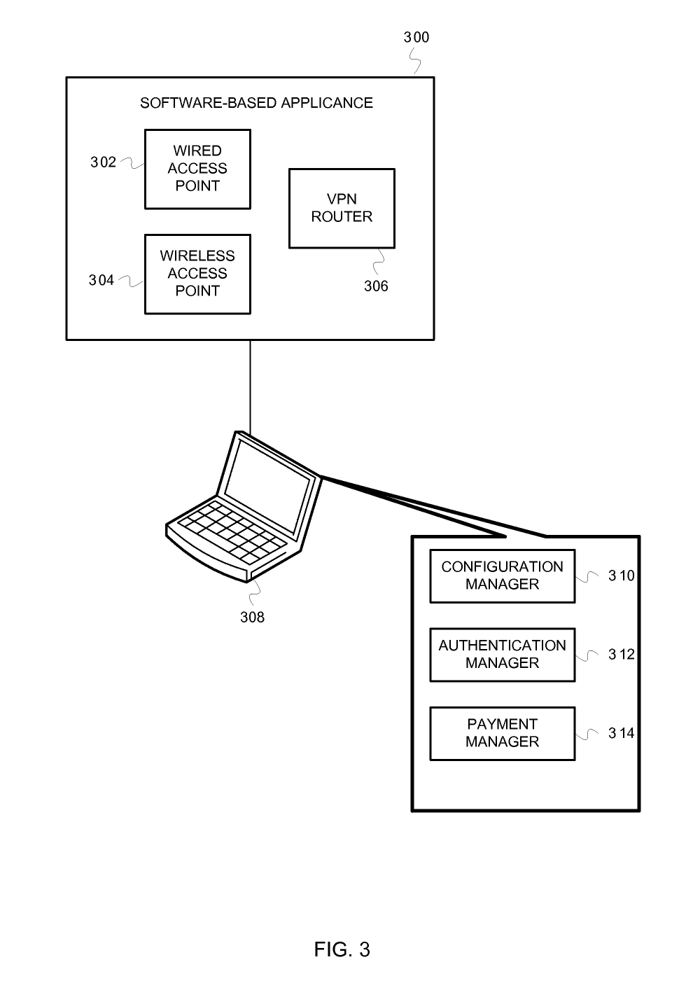

FIG. 3 is a block diagram illustrating a software-based network appliance, according to some embodiments of the inventive subject matter. In FIG. 3, a software-based network appliance 300 includes a wired access point 302, wireless access point 304, and a virtual private network router 306. The wired and wireless access points support an access network that enables mobile devices (i.e. venue customers) to connect with the network appliance 300. The VPN router 306 can routes traffic to a remote services network via a secure tunnel. As similarly described above, the VPN router 306 can route unauthenticated traffic to a remote authentication service via a secure tunnel. The VPN router 306 can also allow traffic from authenticated users to reach the Internet via an unsecured channel.

As shown, the software-based network appliance 300 is connected to a computing device 308. In contrast to the hardware-based network appliance 200, the software-based network appliance may not natively include components for configuring itself upon deployment. However, the software-based appliance 300 can utilize the computing device 308 for automated configuration. For example, upon initial deployment, the computing device's configuration manager 310 can perform operations for configuring the software-based network appliance 300, similarly described above. The network appliance 300 can utilize the authentication manager 312 and payment manager 314 to facilitate user authentication and payment management. The configuration manager 310, authentication manager 312, and payment manager 314 can utilize remote services, as similarly described vis-à-vis the network appliance 200.

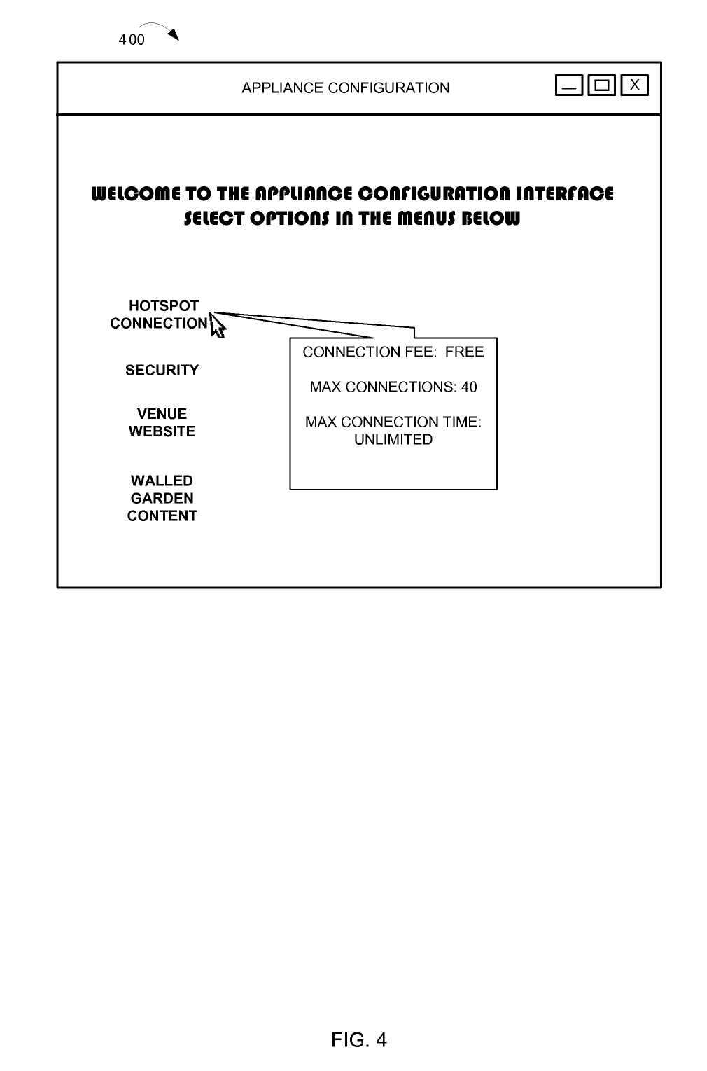

As discussed above, some embodiments offer a configuration website that assists venue operators in selecting configuration options for network appliances. FIG. 4 is a block diagram illustrating a webpage for selecting configuration options for network appliances, according to some embodiments of the inventive subject matter. In FIG. 4, a webpage 400 presents various options. In some embodiments, the configuration options are suited for venue operators who are not experts in telecommunications equipment. For example, the webpage 400 can pose a series of multiple-choice questions about configuration. Answers to the questions reveal the venue operator's preferences, and a remote configuration service selects configuration parameters accordingly. In some embodiments, preferences relate to fees, connection times, maximum number of connections, etc. The webpage 400 may allow venue operators to customize configuration parameters business preferences unrelated to the network itself. For example, a restaurant may have limited seating capacity. The restaurant owner may want to limit network connection times to twenty minutes, so customers do not occupy tables when they are not eating. Similarly, venue owners may provide free Internet connectivity paying customers. The webpage 400 can enable venue owners to configure network appliances to interface with point-of-sale systems to allow paying customers to access the Internet for free.

After a venue operator has selected configuration via the webpage 400, the remote configuration service transmits configuration information to the network appliance. In some embodiments, the webpage 400 enables venue operators to configure their walled gardens, venue-specific websites, and other preferences. The webpage may be hosted by the remote services network or a webserver residing on the network appliance.

In some embodiments, the webpage enables venue operators to select security options for network appliances. As noted above, the security options may be selected after a venue owner answers a series of non-technical questions. In some embodiments, the webpage 400 can facilitate configuration of any parameters supported by a network appliance.

### Configuration Scenarios

There are several scenarios in which venue operators configure their network appliances. In some instances, using a website hosted by the configuration service, a venue operator can select configuration options for a network appliance, where the configuration options are selected from a small number of pre-set configuration profiles. The operator can select a configuration profile, and associate the profile to a particular appliance (e.g., the configuration profile is associated with an appliance serial number). When selecting from the pre-set configuration profiles, the venue operator need not have technical expertise about access networks, subscriber networks, and billing/business options. Instead, the operator may simply select (via the website) a configuration profile based on a simple, lay person's description about the configuration. After selecting the configuration, the venue operator can set-up the appliance at a venue. After each appliance is plugged-into the subscriber network, the appliance provides its serial number to the configuration service. In response, the configuration service can transmit back to the appliance the configuration information that has been selected for that appliance. In turn, the appliance receives the configuration information and automatically configures itself.

In some scenarios, venue operators may want to configure appliances in an on-demand manner. For on-demand configuration, a venue operator can plug-in an appliance to a subscriber network. After plugging-in the appliance, a venue operator can browse to a website hosted by the configuration service. The website enables the venue operator to choose configuration options to load onto the appliance. In some instances, the venue operator may choose a configuration from a detailed list of parameters (e.g., access network parameters, provider network parameters, etc.). In other instances, the venue operator may answer questions about the venue and appliance, where the answers are used to select configuration information for the appliance. After the configuration options are selected via the website, the configuration service transmits configuration information to the appliance. In turn, the appliance can configure itself based on the configuration information.

Technicians can set-up the configuration service's pre-set configuration profiles. Therefore, some embodiments enable the venue owner to access configuration profiles designed by technicians with expertise about access networks, subscriber networks, etc. The configuration information can include the following: venue identifier and location, monetization model, authorization and payment information, venue federation assignment, appliance routing configuration, quality of service parameters, etc.

In other scenarios, the appliance cannot communicate with a subscriber network to reach the configuration service. In such a scenario, a venue operator can plug (e.g., via a Universal Serial Bus connection) the appliance into a laptop computer or other device that has internet connectivity. The configuration service can transmit configuration to the laptop computer, which in turn forwards it to the appliance.

In some scenarios, there are very specific configurations for different locations. For example, there may be different appliance configurations for different zip codes, street addresses, latitude and longitude locations, etc. An appliance deployed in one zip code may have different business/billing parameters then appliances deployed in other zip codes. One reason for this may be that rents are higher in certain zip codes, and therefore Internet access charges are higher in those zip codes. As another example, certain zip codes may have access to certain provider networks, while others have access to other provider networks. The appliances may need different configurations to work with the different subscriber networks.

### Operations

This section describes operations performed by some embodiments of the network appliance and the remote configuration service.

FIG. 5 is a flow diagram illustrating operations for configuring a network appliance, according to some embodiments of the inventive subject matter. The flow 500 begins at block 502, where the network appliance powers-up. For example, after a venue operator deploys the network appliance in the venue and connects it to the power source, the network appliance powers up and begins configuration operations. The flow continues at block 504.

At block 504, the network appliance's access point detects a subscriber network. As discussed above, embodiments of the network appliance use a subscriber network to download configuration parameters from the cloud (e.g., a remote configuration service). The flow continues at block 506.

At block 506, the network appliance's configuration management module transmits, to a remote configuration service, identifying information to a remote configuration service via a secure tunnel. In some embodiments, the appliance's split tunnel VPN client establishes a secure tunnel over the subscriber network with the remote configuration service. In some embodiments, the identifying information includes the network appliance's serial number or other unique identifier, and location information (e.g., street address, longitude and latitude coordinates, zip code, etc.). The flow continues at block 508.

At block 508, the network appliance's configuration management module receives configuration information from the remote configuration service. Configuration information can include parameters for configuring all aspects of the network appliance, including access network parameters, subscriber network parameters, billing business parameters, etc. The flow continues at block 510.

At block 510, the network appliance's configuration management module configures the appliance according to the configuration information. For example, based on the configuration information, the configuration manager module sets the access network's WiFi channels, frequencies, SSID, security protocol (e.g., WPA), etc. The configuration manager module can also use the configuration information to set parameters for the subscriber network, and billing and business parameters. The flow continues at block 512.

At block 512, the configuration management module determines whether an operator has enabled configuration on-demand. Configuration on-demand enables an operator to tweak configuration settings. In some embodiments, the network appliance downloads basic configuration settings from the remote configuration service, while enabling operators to tweak the configuration after the network appliance is up and running. In some embodiments, the network appliance presents configuration on-demand configuration options via a web server residing locally on the appliance. The configuration options may be in the form of questions that do not require technical expertise to answer. Alternatively, the configuration options can be suited for a technical expert. The web server can communicate with the remote configuration service, receiving new configuration parameters and updating the service about the appliance's final configuration after the on-demand configuration is complete. If on-demand configuration has not been selected, the flow continues at block 516. Otherwise, the flow continues at block 514.

At block 514, the configuration management module configures the network appliance according to parameters selected via the on-demand interface. The flow continues at block 516.

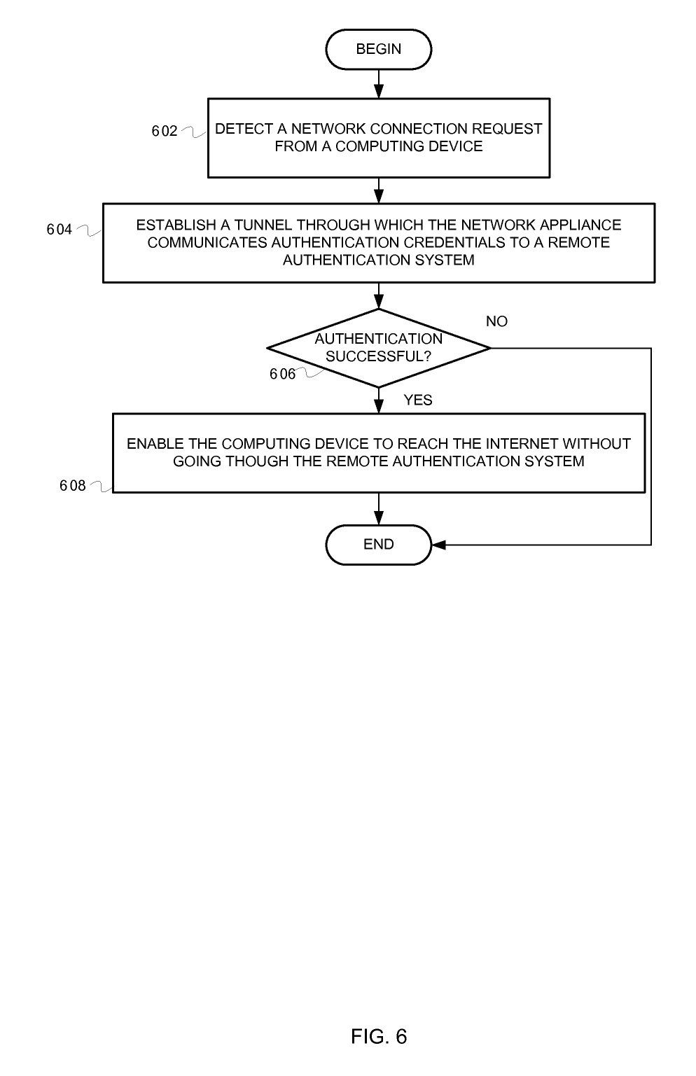

At block 516, after the configuration is complete, the network appliance processes network traffic. From block 516, the flow ends. The discussion of FIG. 6 describes more details about how embodiments of the network appliance may process network traffic.

FIG. 6 is a flow diagram illustrating operations for processing network access requests, according to some embodiments of the inventive subject matter. In FIG. 6, the flow 600 begins at block 602, where the network appliance receives a connection request from a mobile device via the appliance's hotspot. As noted above, mobile devices connect to the network appliance via an access network. The mobile devices provide user credentials as part of requesting access to the network. In some embodiments the access network can utilize Wi-Fi technology, Ethernet technology, or any other suitable networking technology. The flow continues at block 604.

At block 604, as part of servicing the access request, the network appliance's split tunnel VPN client establishes a secure tunnel through which the network appliance communicates authentication credentials to a remote authentication service. The network appliance can communicate with the remote configuration service without an authentication gateway residing on telecom system components. For example, the network appliance need not send network traffic to a gateway residing on the telecom system, where the gateway filters traffic looking for the network access requests, and forwards the requests to the remote configuration service. Instead, the network appliance itself directs network access requests to the remote authentication service via a secure tunnel. The flow continues at block 606.

At block 606, the network appliance determines whether the authentication was successful. That is, the network appliance determines whether the remote authentication service successfully authenticated the user credentials. If the remote authentication service did not authenticate the user credentials, the flow ends. Otherwise, the flow continues at block 608.

At block 608, the network appliance enables network traffic from the user to reach the Internet without passing through the remote authentication system. For example, the network appliance's split tunnel VPN client routes traffic for authenticated users to the Internet, bypassing the remote authentication service. As a result, the network appliance reduces the amount of traffic sent to the remote authentication service. Because less traffic goes to the remote authentication service, users receive web content faster. From block 608, the flow ends.

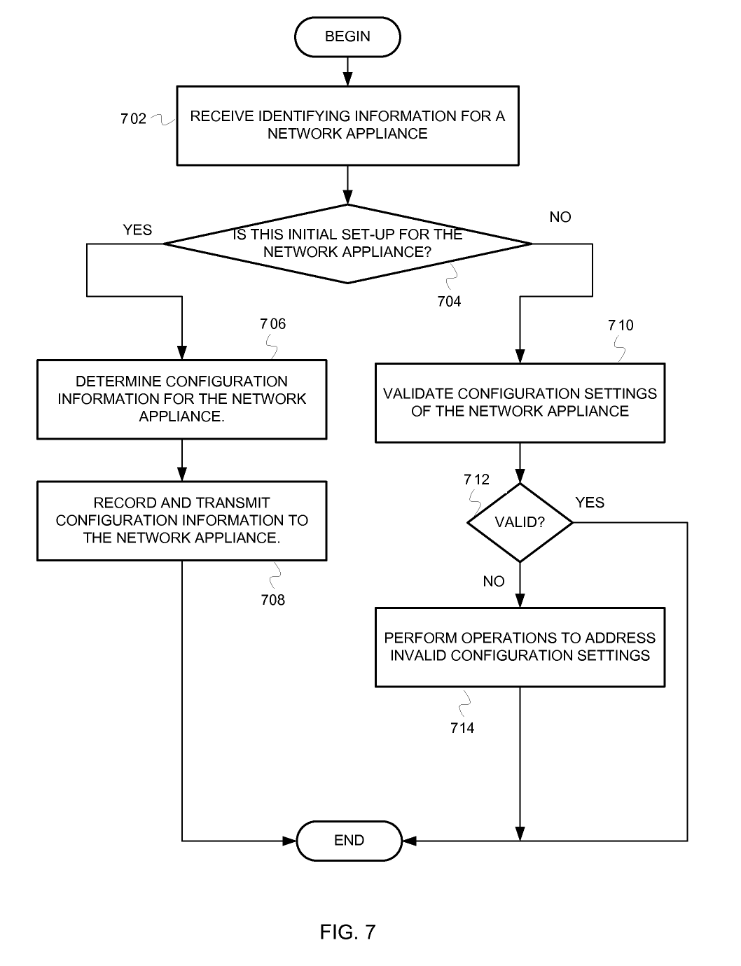

While FIGS. 5 and 6 describe operations performed by embodiments of the network appliance, this discussion continues by describing how a remote configuration service can interact with network appliances. FIG. 7 describes operations performed by the remote configuration service.

FIG. 7 is a flow diagram illustrating operations for providing and verifying configuration information to network appliances, according to some embodiments of the inventive subject matter. In FIG. 7, the flow 700 begins at block 702, where the remote configuration service receives identifying information for a network appliance. For example, the remote configuration service 128 receives a serial number and location information from a network appliance 102. The flow continues at block 704.

At block 704, the configuration service determines whether this is the network appliance's initial configuration. In some embodiments, the configuration service maintains records identifying network appliances that have not yet been initially configured. The records may also indicate network appliances that have already been configured. If this is the network appliance's initial configuration, the flow continues at block 706. Otherwise, the flow continues at block 710.

At block 706, the configuration service determines configuration parameters for the network appliance. As discussed above, a network appliance's initial configuration can be designed by technicians associated with the configuration service, or selected by operators using a configuration website. The configuration parameters can include parameters for an access network, subscriber network, billing/business policies, and any other suitable configuration parameters. The flow continues at block 708.

At block 708, the configuration service records the configuration parameters selected at block 706, and transmits the configuration parameters to the network appliance. As a result, the network appliance can perform an automatic configuration process, and the configuration parameters are stored for safekeeping and future operations. From block 708, the flow ends.

Returning to block 710, after determining that the network appliance has already undergone initial configuration (see 704), the configuration service validates the network appliance's configuration parameters. That is, to ensure proper operation of the network appliance, the configuration service validates the network appliance's configuration parameters and by comparing them to the recorded settings. The flow continues at block 712.

At block 712, if the network appliance's configuration parameters and are valid, the flow ends. Otherwise, the flow continues at block 714, where the configuration service takes measures to address issues with the configuration parameters. For example, if the identifying information indicates that the network appliance has moved, the network appliance determine new configuration information based on the new location. From block 714, the flow ends.

### Comments about Some Embodiments

As will be appreciated by one skilled in the art, aspects of the present inventive subject matter may be embodied as a system, method or computer program product. Accordingly, aspects of the present inventive subject matter may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present inventive subject matter may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present inventive subject matter may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present inventive subject matter are described with reference to flowchart illustrations and/or block diagrams of methods, apparatus (systems) and computer program products according to embodiments of the inventive subject matter. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

While the embodiments are described with reference to various implementations and exploitations, it will be understood that these embodiments are illustrative and that the scope of the inventive subject matter is not limited to them. In general, techniques for configuring and operating network appliances as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the inventive subject matter. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A method for initially configuring a network appliance, the method comprising:
detecting, by the network appliance, a subscriber network;
transmitting, to a remote configuration service via the subscriber network, a request for configuration information for the network appliance;
receiving, via the subscriber network, the configuration information, wherein the configuration information includes first parameters for the subscriber network, and second parameters for an access network for connecting computing devices to the network appliance; and
performing an automated initial configuration of the network appliance using the configuration information, wherein the automated configuration does not require user input, and wherein the automated configuration includes using the first parameters and the second parameters to configure the network appliance for use with the access network and the subscriber network.

2. The method of claim 1 further comprising:
transmitting location information indicating a location of the network appliance, wherein the location information affects values of at least one of the first parameters and the second parameters.

3. The method of claim 1, wherein the configuration information further includes third parameters for determining monetary costs for providing internet connectivity to the computing devices.

4. The method of claim 3 further comprising:
configuring the network appliance to charge specific monetary values for providing internet access to mobile computing devices, wherein network appliance is configured to enable the mobile computing devices to access the internet via the access network and the subscriber network.

5. The method of claim 1 further comprising:
receiving, in the network appliance, a network access request and authentication credentials, wherein the network access request arrives over the access network and originates from a mobile computing device;
transmitting, via a secure virtual private network, the authentication credentials for authentication by a remote authentication service;
receiving, from the remote authentication service, an indication that the authentication credentials have been authenticated;
notifying the mobile computing device that network access is granted;
receiving a request to retrieve content from a website on the internet; and
forwarding the request to the website via an unsecured channel.

6. A network appliance configured to perform automated configuration upon deployment at a venue, the network appliance comprising:
an access network interface configured to connect the network appliance to mobile computing devices;
a subscriber network interface configured to connect the network appliance to a subscriber network;
a configuration unit configured to
determine an identifier and location information associated with the network appliance;
transmit, via the subscriber network interface, the identifier and location information to a remote configuration service;
receive, from the remote configuration service via the subscriber network interface, configuration information for use in configuring the access network interface and the subscriber network interface;
configure the access network interface and the subscriber network interface using the configuration information;
a split tunnel unit configured to
forward authentication requests received from the mobile computing devices to a remote authentication service via a secure virtual private network, wherein the secure virtual private network utilizes the subscriber network; and
forward internet access requests received from authenticated mobile computing devices to the internet via the subscriber network independent of the secure virtual private network.

7. The network appliance of claim 6, wherein the configuration information includes billing information for determining monetary costs for providing internet connectivity to the mobile devices.

8. The network appliance of claim 6, wherein the identifier includes a serial number associated with the network appliance, and wherein the location information includes a zip code in which the network appliance resides.

9. The network appliance of claim 6, wherein the configuration information for configuring the access network interface includes one or more of Internet Protocol addresses for the access network, a Service Set Identifier, WiFi Protected Access protocol information, and WiFi Protected Access II protocol information.

10. The network appliance of claim 6, wherein the configuration information for configuring the subscriber network interface includes Dynamic Host Configuration Protocol information and Domain Name Server information.

11. A computer-readable storage device including instructions which when executed by a computing device cause the computing device to perform operations for initially configuring a network appliance, the instructions comprising:
instructions to detect, by the network appliance, a subscriber network;
instructions to transmit, to a remote configuration service via the subscriber network, a request for configuration information for the network appliance;
instructions to receive, via the subscriber network, the configuration information, wherein the configuration information includes first parameters for the subscriber network, and second parameters for an access network for connecting computing devices to the network appliance; and
instructions to perform an automated initial configuration of the network appliance using the configuration information, wherein the automated configuration does not require user input, and wherein the automated configuration includes using the first parameters and the second parameters to configure the network appliance for use with the access network and the subscriber network.

12. The computer readable storage device of claim 11, the instructions further comprising:
instructions to transmit location information indicating a location of the network appliance, wherein the location information affects values of at least one of the first parameters and the second parameters.

13. The computer readable storage device of claim 11, wherein the configuration information further includes third parameters for determining monetary costs for providing internet connectivity to the computing devices.

14. The computer readable storage device of claim 13, the instructions further comprising:
instructions to configure the network appliance to charge specific monetary values for providing internet access to mobile computing devices, wherein network appliance is configured to enable the mobile computing devices to access the internet via the access network and the subscriber network.

15. The computer readable storage device of claim 11, the instructions further comprising:
receiving, in the network appliance, a network access request and authentication credentials, wherein the network access request arrives over the access network and originates from a mobile computing device;
transmitting, via a secure virtual private network, the authentication credentials for authentication by a remote authentication service;
receiving, from the remote authentication service, an indication that the authentication credentials have been authenticated;
notifying the mobile computing device that network access is granted;
receiving a request to retrieve content from a website on the internet; and
forwarding the request to the website via an unsecured channel.
